(19) United States
(12) Patent Application Publication
(10) Pub. No.: US 2025/0021855 A1
(43) Pub. Date: Jan. 16, 2025

(54) Quantum Neural Network Systems and Methods Using Quantum Embedding

(71) Applicant: Lockheed Martin Corporation, Bethesda, MD (US)

(72) Inventors: Nicholas Sven Shorter, Orlando, FL (US); Joshua Adam Job, Los Angeles, CA (US); Steven Hiroshi Adachi, San Ramon, CA (US); Julia Kwok, Albuquerque, NM (US); Danielle Marie Couger, Littleton, CO (US); Derek Keith Wise, Highlands Ranch, CO (US)

(21) Appl. No.: 18/589,534

(22) Filed: Feb. 28, 2024

Related U.S. Application Data
(60) Provisional application No. 63/487,571, filed on Feb. 28, 2023.

(51) Int. Cl. G06N 10/20

(52) U.S. Cl. CPC G06N 10/20

(57) ABSTRACT

According to an embodiment, a method includes removing a last feed forward layer from a pre-trained neural network. The method further includes appending the pre-trained neural network with a secondary last feed forward layer configured to output a plurality of parameters. The method further includes updating each one of the plurality of parameters by: 1) multiplying each one of the plurality of parameters by a first factor to produce a plurality of resultant parameters; and 2) adding a second term to each one of the plurality of resultant parameters, wherein both the first factor and the second term vary due to backpropagation. The method further includes using a loss function to determine the distance between a known class embedding and an input from an input dataset. Lastly, the method includes updating one or more weights associated with the number of variables in the pre-trained neural network.

### CROSS-REFERENCE TO RELATED APPLICATIONS

This application is a Non-Provisional application claiming priority to Provisional Patent Application Ser. No. 63/487,571, entitled “Quantum Embedding,” filed on Feb. 28, 2023, which is incorporated herein by reference in its entirety.

### TECHNICAL FIELD

This disclosure generally relates to quantum neural networks (QNNs).

### BACKGROUND

Quantum computers have the potential to surpass classical computers by taking advantage of quantum-mechanical phenomena such as superposition, interference, and entanglement. However, realizing the potential advantage of quantum computing requires the use of quantum algorithms, which may be tailored to the application or problem being solved. One type of application that is being actively studied is machine learning. There is a need for an improved system that can operate on large data sets occurring in problems such as image classification.

### SUMMARY OF THE DISCLOSURE

While quantum computers may not yet contain enough quantum bits (qubits) to operate on said large data sets, it may be possible to attack these problems using a hybrid architecture consisting of both classical and quantum computers. Technical advantages of certain embodiments of this disclosure may include one or more of the following. In certain embodiments, the QNN described herein identifies or labels certain data. The QNN may be finetuned on a dataset of interest using auto augmentation, sharpness aware minimization, and/or cosine learning rate decay. Further, in prior instances, a feature extracting network that processes data into a certain feature representation (i.e., a pre-trained neural network), herein referred to as a “backbone”, may be frozen or untrained with a given dataset. The present disclosure may provide a QNN wherein the backbone and/or added nodes to the network may be trainable (i.e., not frozen). Certain embodiments of the disclosure additionally may provide the QNN performing affine transformation parameterization for rotation gates in circuit ansatz inputs.

In certain embodiments, this disclosure may particularly be integrated into a practical application of improving underlying operations of computing systems tasked to perform an operation for one or more users. For example, the disclosed system may reduce processing, memory, and time resources and improve accuracy of a computing system for identifying certain data. In this example, the disclosed system may process datasets in a reduced period of time by finetuning through auto augmentation, sharpness aware minimization, and/or cosine learning rate decay. In another example, the disclosed system may model more complex relationships with respect to feed forward classical neural networks, may execute quantum data faster than classical algorithms, and can be trained with less training samples than classical algorithms

Other technical advantages will be readily apparent to one skilled in the art from the following figures, descriptions, and claims. Moreover, while specific advantages have been enumerated above, various embodiments may include all, some, or none of the enumerated advantages.

According to some embodiments, a method comprises removing a last feed forward layer from a pre-trained neural network and introducing a secondary last feed forward layer. The method further comprises determining a number of measurements based on a plurality of qubits and a plurality of parameters output from the secondary last feed forward layer. The method further comprises using a cross-entropy loss function to determine the difference between a probability distribution for a number of variables and a true value for each of the number of variables, wherein the probability distribution is based on the determined number of measurements. The method further comprises updating one or more weights associated with the number of variables in the pre-trained neural network through an optimizer.

According to other embodiments, a hybrid quantum machine learning system comprises a classical computing subsystem and a quantum computing subsystem. The classical computing subsystem is configured to remove a last feed forward layer from a pre-trained neural network and to introduce a secondary last feed forward layer. The quantum computing subsystem is configured to determine a number of measurements based on a plurality of qubits and a plurality of parameters output from the secondary last feed forward layer. The classical computing subsystem is further configured to use a cross-entropy loss function to determine the difference between a probability distribution for a number of variables and a true value for each of the number of variables, wherein the probability distribution is based on the determined number of measurements. The classical computing subsystem is further configured to update one or more weights associated with the number of variables in the pre-trained neural network through an optimizer.

According to other embodiments, a non-transitory computer-readable medium comprises instructions that are configured, when executed by one or more processor, to remove a last feed forward layer from a pre-trained neural network and to introduce a secondary last feed forward layer. The instructions further cause the one or more processors to determine a number of measurements based on a plurality of qubits and a plurality of parameters output from the secondary last feed forward layer. The instructions further cause the one or more processors to use a cross-entropy loss function to determine the difference between a probability distribution for a number of variables and a true value for each of the number of variables, wherein the probability distribution is based on the determined number of measurements. The instructions further cause the one or more processors to update one or more weights associated with the number of variables in the pre-trained neural network through an optimizer.

According to some embodiments, a method comprises removing a last feed forward layer from a pre-trained neural network and introducing a secondary last feed forward layer configured to output a plurality of parameters. The method further comprises updating each one of the plurality of parameters output from the secondary last feed forward layer by: 1) multiplying each one of the plurality of parameters by a first factor to produce a plurality of resultant parameters; and 2) adding a second term to each one of the plurality of resultant parameters, wherein both the first factor and the second term vary due to backpropagation. The method further comprises determining a number of measurements based on a plurality of qubits and the updated plurality of parameters. The method further comprises using a loss function to determine the difference between a probability distribution for a number of variables and a true value for each of the number of variables, wherein the probability distribution is based on the determined number of measurements. The method further comprises updating one or more weights associated with the number of variables in the pre-trained neural network through an optimizer.

According to other embodiments, a hybrid quantum machine learning system comprises a classical computing subsystem and a quantum computing subsystem. The classical computing subsystem is configured to remove a last feed forward layer from a pre-trained neural network and to introduce a secondary last feed forward layer configured to output a plurality of parameters. The quantum computing subsystem is configured to update each one of the plurality of parameters output from the secondary last feed forward layer by: 1) multiplying each one of the plurality of parameters by a first factor to produce a plurality of resultant parameters; and 2) adding a second term to each one of the plurality of resultant parameters, wherein both the first factor and the second term vary due to backpropagation. The quantum computing subsystem is further configured to determine a number of measurements based on a plurality of qubits and the updated plurality of parameters. The classical computing subsystem is further configured to use a loss function to determine the difference between a probability distribution for a number of variables and a true value for each of the number of variables, wherein the probability distribution is based on the determined number of measurements. The classical computing subsystem is further configured to update one or more weights associated with the number of variables in the pre-trained neural network through an optimizer.

According to other embodiments, a non-transitory computer-readable medium comprises instructions that are configured, when executed by one or more processor, to remove a last feed forward layer from a pre-trained neural network and to introduce a secondary last feed forward layer configured to output a plurality of parameters. The instructions further cause the one or more processors to update each one of the plurality of parameters output from the secondary last feed forward layer by: 1) multiplying each one of the plurality of parameters by a first factor to produce a plurality of resultant parameters; and 2) adding a second term to each one of the plurality of resultant parameters, wherein both the first factor and the second term vary due to backpropagation. The instructions further cause the one or more processors to determine a number of measurements based on a plurality of qubits and the updated plurality of parameters. The instructions further cause the one or more processors to use a loss function to determine the difference between a probability distribution for a number of variables and a true value for each of the number of variables, wherein the probability distribution is based on the determined number of measurements. The instructions further cause the one or more processors to update one or more weights associated with the number of variables in the pre-trained neural network through an optimizer.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a diagram illustrating an example embodiment of a quantum neural network (QNN), according to particular embodiments;

FIG. 2 is a diagram illustrating a parameterized quantum circuit that utilizes QNN cross entropy, according to particular embodiments;

FIG. 3 is a diagram illustrating a parameterized quantum circuit that utilizes QNN quantum embedding, according to particular embodiments;

FIGS. 4A-4C are diagrams illustrating example operations of the QNN of FIG. 1, according to particular embodiments; and

FIG. 5 illustrates an example computer system, according to certain embodiments.

### DESCRIPTION OF EXAMPLE EMBODIMENTS

### Overview

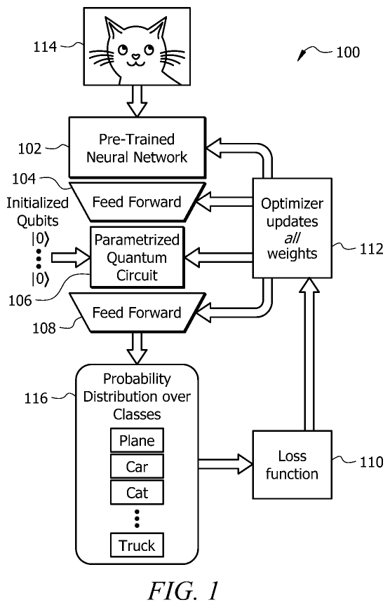

To facilitate a better understanding of the present disclosure, the following examples of certain embodiments are given. The following examples are not to be read to limit or define the scope of the disclosure. Embodiments of the present disclosure and its advantages are best understood by referring to FIGS. 1 through 5, where like numbers are used to indicate like and corresponding parts.

A quantum neural network (QNN) may be a software algorithm or computational machine learning model that involves combining ideas from artificial intelligence, machine learning, and/or quantum computing. Existing QNNs may typically be evaluated on smaller, toy/niche datasets, not larger benchmark datasets and only compared to a handful of classical neural networks also evaluated on those same datasets. A more rigorous approach may be to evaluate the QNN on a benchmark dataset capturing the same parameters and metrics as several hundred classical neural networks that were also evaluated on that same dataset.

To address problems with current QNNs, embodiments of the disclosure seek to label or identify data by taking previously labeled data, such as images with annotated objects or time series data with known outputs, and training on that data to understand the relationship or mapping from the data to the labels. The disclosed embodiments may label data that has no labels but comes from the same or similar distribution of data. A concrete example of this would be if it had previously been identified which images contained cats from a set of images. The disclosed embodiments then train on the images labeled with cats. Then, when fed future unlabeled images (e.g., where it had not been identified if there were cats in those images), the disclosed embodiments may identify if there were cats in those images. To accomplish this, the disclosed embodiments utilize novel training techniques and evaluation using a quantum computer.

The disclosed embodiments provide the first quantum-enabled approach to be evaluated on the CIFAR-10 benchmark dataset. This is unique because other quantum solutions have only been evaluated on smaller toy/niche datasets, not benchmark datasets, and have only been compared to a handful of classical neural networks evaluated on those same datasets. Thus their performance and validation is inferior to an approach using a benchmark dataset that has 200+ other classical neural network approaches evaluated against it. By evaluating the disclosed hybrid classical quantum neural network approach on an Al/ML benchmark dataset such as the CIFAR-10 dataset, performance can be compared to 200+ purely classical neural network approaches.

The disclosed embodiments may utilize a classical neural network that is trained on a large dataset of known images, such as ImageNet. This classical neural network is then appended with a QNN and is then finetuned on a dataset of interest, such as the CIFAR-10 dataset. In some embodiments, auto augmentation, sharpness aware minimization and/or a cosine learning rate decay are utilized to fine-tune a hybrid classical quantum neural network. In some embodiments, the rotation gate inputs for the quantum circuit ansatz are augmented with additional parameters to enhance the model's expressivity, as discussed in more detail below.

### Example Embodiments

FIG. 1 illustrates an example embodiment of a QNN 100, according to certain embodiments. In embodiments, the QNN 100 may comprise a pre-trained neural network 102, or a “backbone,” a first feed forward layer 104, a quantum circuit 106, a second feed forward layer 108, a loss function 110, and an optimizer 112. The pre-trained neural network 102 may be any suitable feature extracting network capable of processing data into a certain feature representation. For example, the pre-trained neural network 102 may be an EfficientNet model. In embodiments, the pre-trained neural network 102 may be trained using quantum hardware and/or a software simulator such as Tensorflow Quantum. The pre-trained neural network 102 may be initially trained to identify data on a designated dataset 114, wherein the dataset 114 may comprise images and/or time series data. The dataset 114 is not limited to such types of data and may include other various types of data for training a neural network. In embodiments, while the pre-trained neural network 102 may be initially trained with a first dataset, such as dataset 114, the provided QNN 100 may evaluate a second dataset different from dataset 114. For example, the second dataset may comprise different-sized data and/or a different number of individual datum. In these embodiments, weights within the components of the QNN 100 may be iteratively updated for evaluating different datasets, such as the pre-trained neural network 102 and/or the quantum circuit 106 (i.e., they are not frozen).

As shown in FIG. 1, the first feed forward layer 104 may be introduced after and receive outputs from the pre-trained neural network 102. In embodiments, the pre-trained neural network 102 may initially comprise a last feed forward layer associated with the number of parameters to be output for the dataset on which it was trained. Here, the initial last feed forward layer may be removed and replaced by the first feed forward layer 104, wherein the first feed forward layer 104 may be configured to output a number of parameters less than a number of parameters from the initial last feed forward layer.

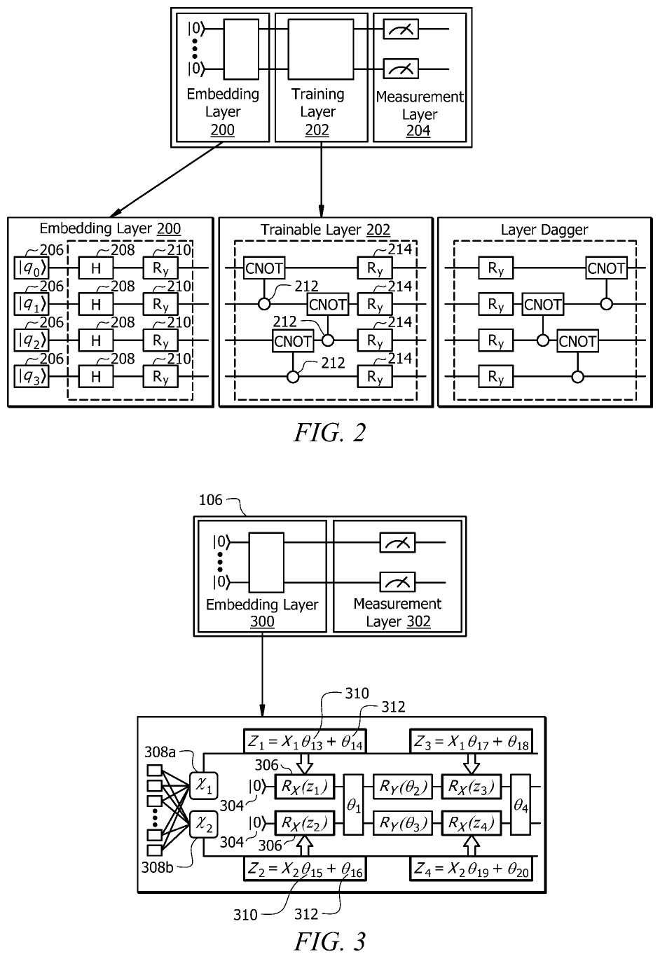

The quantum circuit 106 may be configured to receive the number of parameters output from the first feed forward layer 104 and a plurality of qubits. The quantum circuit 106 may be parameterized based on the received number of parameters and may be configured to determine a number of measurements based on the qubits and the parameters, as discussed further below in FIGS. 2-3. In embodiments, the determined measurements may be received by the second feed forward layer 108. The second feed forward layer 108 may comprise a softmax activation function configured to output a probability distribution 116 spanning a number of classes for the second dataset being evaluated by the QNN 100, wherein the probability distribution 116 may be based on the determined number of measurements. In embodiments, the individual classes may represent categories in which data from a second dataset is to be classified into during evaluation.

The QNN 100 may utilize the loss function 110 to determine the difference between the probability distribution 116 for a number of variables and a true value for each of the number of variables. Any suitable loss function may be used as the loss function 110. For example, the loss function 110 may be a cross-entropy loss function, a Hilbert-Schmidt loss function, a mean squared error loss function, a mean absolute error loss function, a mean squared logarithmic loss function, a huber loss function, a hinge loss function, and the like. In embodiments, the optimizer 112 may receive input from the loss function 110 and may be configured to update one or more weights associated with the number of variables in the pre-trained neural network 102. The optimizer 112 may be further configured to update the one or more weights in the pre-trained neural network 102, first feed forward layer 104, the quantum circuit 106, and/or in the second feed forward layer 108. The QNN 100 may iteratively update the one or more weights to increase the accuracy of evaluating any secondary dataset.

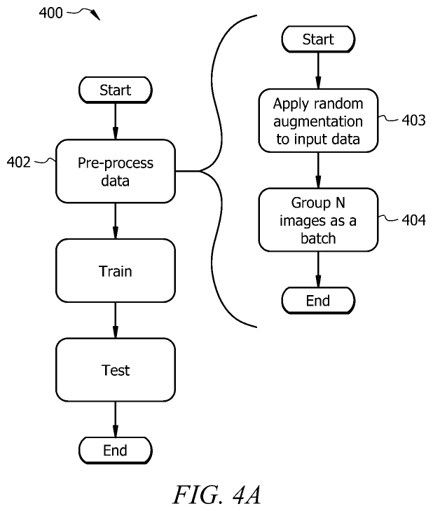

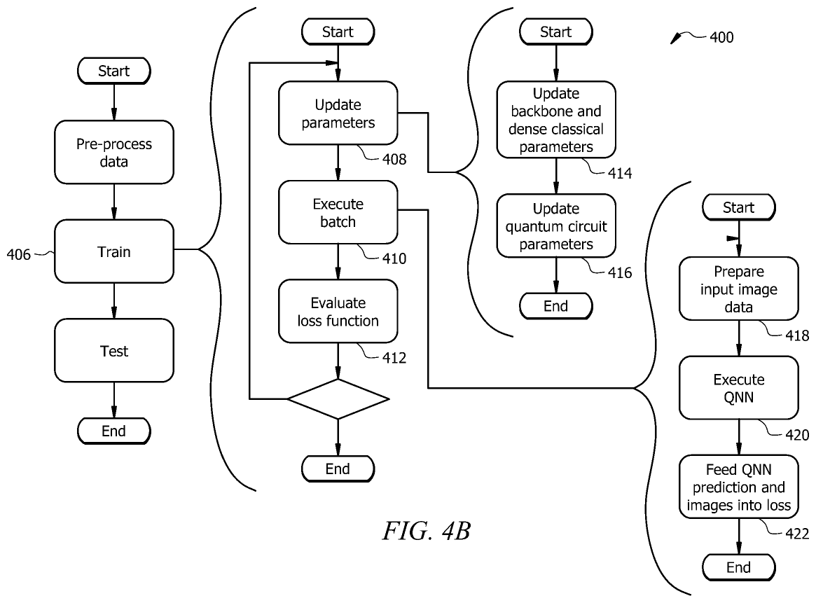

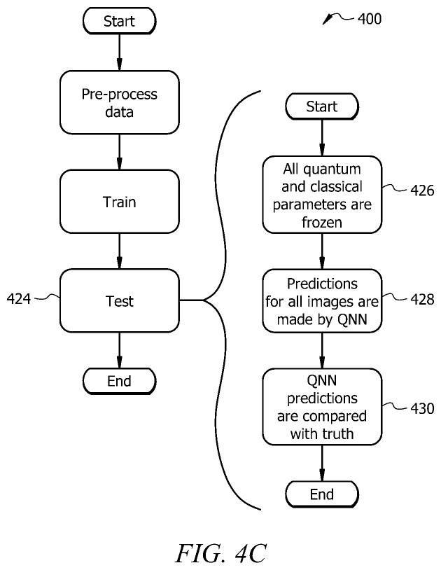

In one or more embodiments, input data may undergo auto augmentation prior to being received by the pre-trained neural network 102. The optimizer 112, specifically the learning rate, may use cosine learning rate decay. The loss function 110 may include sharpness aware minimization. (see description for FIG. 4A below).

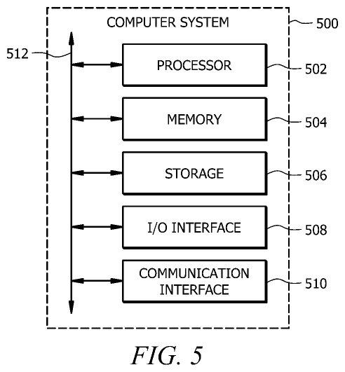

In certain embodiments, pre-trained neural network 102, the first feed forward layer 104, and the second feed forward layer 108 may be implemented on a GPU or any other appropriate type of computing device. In these embodiments, the quantum circuit 106 may be implemented on a quantum computer simulator or an actual quantum computer. The remaining components of the system of FIG. 1 may be implemented on a conventional CPU-based processor. An example computing system that may be utilized to implement one or more components of FIG. 1 is illustrated in FIG. 5.

### ONN Cross Entropy

FIG. 2 illustrates an example embodiment of the quantum circuit 106 for use in an example QNN 100 (referring to FIG. 1) using a cross-entropy loss function as the loss function 110 (referring to FIG. 1). In embodiments, quantum circuit 106 may comprise an embedding layer 200, at least one training layer 202, and a measurement layer 204. The embedding layer 200 may receive one or more qubits 206 each having an initial value. The one or more qubits 206 may be processed by one or more Hadamard gates 208 in the embedding layer 200, or any other suitable quantum gates. The embedding layer 200 may further comprise a plurality of rotation gates 210 configured to receive the number of parameters output from the first feed forward layer 104 (referring to FIG. 1). In embodiments, there may be an equivalent number of one or more qubits 206 and rotation gates 210 or a different number of one or more qubits 206 with respect to the rotation gates 210.

The at least one training layer 202 may comprise one or more controlled NOT gates 212 that may be configured to entangle the one or more qubits 206, which may then be input into one or more secondary rotation gates 214. In embodiments, both the rotation gates 210, 214 may be parameterized and may be updated through backpropagation via the optimizer 112 (referring to FIG. 1) of the QNN 100. In embodiments, backpropagation herein refers to a process for computing the gradient of a loss function with respect to the weights of a network for a single input-output example; computing the gradient one layer at a time; and iterating backward from the last layer to avoid redundant calculations of intermediate terms in the Leibniz chain rule. In certain embodiments, the quantum circuit 106 may undergo dagger initialization to determine the initial weights of the parameterized rotation gates 210, 214. The measurement layer 204 may be configured to convert a quantum state vector into a set of real numbers that a classical computer can understand for processing.

### ONN Quantum Embedding

FIG. 3 illustrates an example embodiment of the quantum circuit 106 for use in an example QNN 100 (referring to FIG. 1) using quantum embedding. In embodiments, the quantum circuit 106 may comprise an embedding layer 300 and a measurement layer 302. Similar to embedding layer 200 (referring to FIG. 2), the embedding layer 300 may receive one or more qubits 304 each having an initial value and may comprise a plurality of rotation gates 306 configured to receive a number of parameters 308 output from the first feed forward layer 104 (referring to FIG. 1), wherein the rotation gates 306 may process both the one or more qubits 304 and the number of parameters 308 (individually shown in FIGS. 3 as 308a and 308b). As illustrated, the number of parameters 308 may be updated or processed prior being input into the rotation gates 306. The embedding layer 300 may be configured to multiply each one of the number of parameters 308 by a first factor 310 to produce a plurality of resultant parameters and add a second term 312 to each one of the plurality of resultant parameters, wherein both the first factor 310 and the second term 312 may vary due to backpropagation. As such, in these embodiments, the parameterized quantum circuit 106 may undergo iterative updates for the number of parameters 308 (referred to as “affine transformation parameterization” for the rotation gates 306 in a circuit ansatz).

In embodiments, the output of the parameterized quantum circuit 106 may be further processed by the QNN 100 with the loss function 110 (referring to FIG. 1). In these embodiments, the loss function 110 may be a Hilbert-Schmidt loss function to maximize separation of different class embeddings. Classification may then be done by taking a fidelity measurement for a given input with each of the embedded classes and assigning that input to the class which has the largest overlap with the input. For example, the Hilbert-Schmidt loss function may produce separate convergences of class clusters, wherein the individual class clusters comprise data having overlapping characteristics. An example algorithmic summary of operation may begin by first determining a metric. Then, the QNN 100 may train the embedding circuit using data and a metric-dependent cost function, which may be the Hilbert-Schmidt loss. For newer input data, the QNN 100 may embed with the obtained optimal parameters then classify said input data with corresponding quantum measurements. The QNN 100 may use an embedding function to embed the classical data points in order to calculate ensembles. The data ensembles may be used by the Hilbert-Schmidt loss function to optimize the embedding function parameters. In embodiments, the measurement layer 302 may comprise of fidelity measurements and may be configured to convert quantum state vectors into real numbers that a classical computer can understand for processing.

FIGS. 4A-4C are flow charts that illustrate an example method 400 of the QNN 100 (referring to FIG. 1) for labelling or identifying data within the disclosed embodiments. Method 400 may be used for either QNN cross entropy or quantum embedding.

FIG. 4A illustrates a portion of method 400 implemented by the QNN 100 for auto augmentation. FIG. 4A may illustrate the overall flow of how QNN 100 may operate, but the sub-steps shown herein provide description related to the auto augmentation process. In embodiments, the method 400 may be performed by one or more computer systems (such as computer system 500 below in FIG. 5). The method 400 may begin at operation 402 where the QNN 100 may receive a dataset to be evaluated. In embodiments, the data within the received dataset may be pre-processed prior to evaluation. The pre-processing may include performing auto augmentation on the dataset. In an example, auto augmentation may occur before the data is presented to the QNN 100 and before training happens in a subsequent operation. Operation 402 may comprise sub-operation 403 and sub-operation 404. At sub-operation 403, a certain distribution of random transformations may be applied to image data (e.g., a certain distribution of offsets, rotations, cropping, etc. are applied to the images prior to them being trained on the neural network). Then several of the individual images may be presented at the same time to the QNN 100 as a batch at sub-operation 404.

FIG. 4B illustrates a portion of method 400 implemented by the QNN 100 for an iterative training loop in the disclosed embodiments. After operation 402, the method 400 may proceed to operation 406 where the iterative training process is provided. Operation 406 may comprise sub-operation 408, sub-operation 410, and sub-operation 412. At sub-operation 408, the QNN 100 may update the parameters of the various components within QNN 100. In embodiments, the optimizer 112 (referring to FIG. 1) may be configured to perform the updating after receiving results from the loss function 110 (referring to FIG. 1). At a first step 414 of sub-operation 408, the optimizer 112 may update one or more weights associated with the number of variables in the pre-trained neural network 102 (referring to FIG. 1), the first feed forward layer 104 (referring to FIG. 1), and/or the second feed forward layer 108 (referring to FIG. 1). At a second step 416 of sub-operation 408, the optimizer 112 may update the one or more weights associated with the variables of the quantum circuit 106 (referring to FIG. 1). This may be in contrast to typical systems wherein the pre-trained neural network 102 (or “backbone”) remains frozen. Here, the pre-trained neural network 102 is not frozen. Instead, the parameters/weights may be updated as described herein.

The method 400 may then proceed to sub-operation 410, wherein the QNN 100 may execute a “batch” or grouping of data. Here, a batch of images or group of images may be processed with the QNN 100. The QNN 100 may make a guess of what is in the images. Sub-operation 410 may comprise a first step 418, a second step 420, and a third step 422. At first step 418 of sub-operation 410, an input dataset may be prepared or pre-processed as previously described in operation 402. At second step 420 of sub-operation 410, The input dataset may be received and evaluated by QNN 100. At third step 422 of sub-operation 410, the predicted probability distribution 116 (referring to FIG. 1) of the identified data may be transmitted to the loss function 110.

At sub-operation 412, the loss function 110 may return a value based on how well the QNN 100 performed. It may be desirable to minimize the loss function 110 results. When the QNN 100 performs well, the loss value may be low. When the QNN 100 performs poorly, the loss value may be high. The output of that loss value is a metric that may reflect how much the weights need to be adjusted for given variables. The metric may then be input to the optimizer 112 and the optimizer 112 may update said weights. The optimizer 112 may utilize cosine learning rate decay to adjust the learning rate to control how large or small in magnitude to adjust the weights. The loss function 110 may comprise sharpness aware minimization which simultaneously minimizes the loss value and loss sharpness by seeking parameters that are in neighborhoods having uniformly low loss.

FIG. 4C illustrates a portion of method 400 implemented by the QNN 100 for a testing operation 424. Once the QNN 100 has been trained and there are no more labels, the parameters are no longer changed and predictions may be made. Before testing operation 424, the QNN 100 may have been trained within operation 406. Once trained and the necessary parameters have been updated, the QNN 100 may receive a dataset during sub-operation 426. The QNN 100 may process the received dataset and predict which classes to label the data within the dataset in sub-operation 428. In sub-operation 430, the predictions may be compared to the true values of the dataset and a resulting accuracy may be determined (i.e., 98.9% correctly labeled data). The method 400 may then proceed to end.

FIG. 5 illustrates a computer system 500, in accordance with certain embodiments. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate. For example, parallel processing may occur across multiple computer systems 500 for classical machine learning algorithms and/or for quantum simulation. In embodiments, the computer system 500 may include a classical computing subsystem and a quantum computing subsystem. The computer system 500 may be implemented using shared hardware or separate hardware. In certain embodiments, computer system 500 may be distributed in a cloud network environment.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic.

Modifications, additions, or omissions may be made to the methods described herein without departing from the scope of the disclosure. The methods may include more, fewer, or other steps. Additionally, steps may be performed in any suitable order. That is, the steps of any method disclosed herein do not have to be performed in the exact order disclosed, unless explicitly stated.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or.” Similarly, as used in this document “and” is not necessarily inclusive and, unless expressly indicated otherwise, can be inclusive in certain embodiments and can be understood to mean “and/or.” All references to “a/an/the element, apparatus, component, means, step, etc.” are to be interpreted openly as referring to at least one instance of the element, apparatus, component, means, step, etc., unless explicitly stated otherwise.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference to an apparatus, system, or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, comprising:
removing a last feed forward layer from a pre-trained neural network;
introducing a secondary last feed forward layer configured to output a plurality of parameters;
updating each one of the plurality of parameters output from the secondary last feed forward layer by:
multiplying each one of the plurality of parameters by a first factor to produce a plurality of resultant parameters; and
adding a second term to each one of the plurality of resultant parameters, wherein both the first factor and the second term vary due to backpropagation;
executing a quantum circuit to determine a number of measurements based on a plurality of qubits and the updated plurality of parameters;
using a loss function to determine a distance between a known class embedding and an input from an input dataset; and
updating one or more weights associated with a number of variables in the pre-trained neural network through an optimizer.

2. The method of claim 1, wherein the secondary last feed forward layer is configured to output a number of parameters less than a number of parameters from the last feed forward layer.

3. The method of claim 1, wherein the quantum circuit receives the plurality of qubits and the plurality of parameters to determine the number of measurements.

4. The method of claim 1, further comprising performing auto augmentation on the input dataset to be processed by a quantum neural network.

5. The method of claim 1, wherein the optimizer is configured to update the one or more weights in the secondary last feed forward layer and in the quantum circuit.

6. The method of claim 1, wherein the optimizer is configured to use cosine learning rate decay and/or sharpness aware minimization.

7. The method of claim 1, wherein the loss function is a Hilbert-Schmidt loss function.

8. A hybrid quantum machine learning system, comprising:
a classical computing subsystem configured to:
remove a last feed forward layer from a pre-trained neural network; and
introduce a secondary last feed forward layer configured to output a plurality of parameters; and
a quantum computing subsystem configured to:
update each one of the plurality of parameters output from the secondary last feed forward layer by:
multiplying each one of the plurality of parameters by a first factor to produce a plurality of resultant parameters; and
adding a second term to each one of the plurality of resultant parameters,
wherein both the first factor and the second term vary due to backpropagation; and
execute a quantum circuit to determine a number of measurements based on a plurality of qubits and the updated plurality of parameters,
wherein the classical computing subsystem is further configured to:
use a loss function to determine a distance between a known class embedding and an input from an input dataset; and
update one or more weights associated with a number of variables in the pre-trained neural network through an optimizer.

9. The hybrid quantum machine learning system of claim 8, wherein the secondary last feed forward layer is configured to output a number of parameters less than a number of parameters from the last feed forward layer.

10. The hybrid quantum machine learning system of claim 8, wherein the quantum circuit receives the plurality of qubits and the plurality of parameters to determine the number of measurements.

11. The hybrid quantum machine learning system of claim 8, wherein the hybrid quantum machine learning system is configured to perform auto augmentation on the input dataset to be processed by a quantum neural network.

12. The hybrid quantum machine learning system of claim 8, wherein the optimizer is configured to update the one or more weights in the secondary last feed forward layer and in the quantum circuit.

13. The hybrid quantum machine learning system of claim 8, wherein the optimizer is configured to use cosine learning rate decay and/or sharpness aware minimization.

14. The hybrid quantum machine learning system of claim 8, wherein the loss function is a Hilbert-Schmidt loss function.

15. A non-transitory computer-readable medium comprising instructions that are configured, when executed by one or more processors, to:
remove a last feed forward layer from a pre-trained neural network;
introduce a secondary last feed forward layer configured to output a plurality of parameters;
update each one of the plurality of parameters output from the secondary last feed forward layer by:
multiplying each one of the plurality of parameters by a first factor to produce a plurality of resultant parameters; and
adding a second term to each one of the plurality of resultant parameters, wherein both the first factor and the second term vary due to backpropagation;
execute a quantum circuit to determine a number of measurements based on a plurality of qubits and the updated plurality of parameters;
use a loss function to determine a distance between a known class embedding and an input from an input dataset; and
update one or more weights associated with a number of variables in the pre-trained neural network through an optimizer.

16. The non-transitory computer-readable medium of claim 15, wherein the loss function is a Hilbert-Schmidt loss function.

17. The non-transitory computer-readable medium of claim 15, wherein the quantum circuit receives the plurality of qubits and the plurality of parameters to determine the number of measurements.

18. The non-transitory computer-readable medium of claim 15, wherein the instructions are further configured to:
perform auto augmentation on the input dataset to be processed by a quantum neural network.

19. The non-transitory computer-readable medium of claim 15, wherein the instructions are further configured to:
update the one or more weights in the secondary last feed forward layer and in the quantum circuit.

20. The non-transitory computer-readable medium of claim 15, wherein the optimizer is configured to use cosine learning rate decay and/or sharpness aware minimization.
